(19) United States
(12) Patent Application Publication
(10) Pub. No.: US 2001/0043533 A1
(43) Pub. Date: Nov. 22, 2001

(54) Optical reader/player preventing the unauthorized reading of information-carrying substrates

(76) Inventors: Jerry L. Hahnfeld, Midland, MI (US); Walter C. Buzanowski, Midland, MI (US); Mary A. Leugers, Midland, MI (US); Marianne L. McKelvy, Midland, MI (US); Henri-Luc Martin, Midland, MI (US); Thomas J. Wainerdi, Katy, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/776,062

(22) Filed: Feb. 2, 2001

Related U.S. Application Data
(60) Provisional application No. 60/186,809, filed on Mar. 3, 2000.
(60) Provisional application No. 60/196,220, filed on Apr. 11, 2000.

(51) Int. Cl. G11B 7/00

(52) U.S. Cl. 369/53.22

(57) ABSTRACT

An optical reader/player for reading and reproducing signals stored in an optical recording medium (CD, DVD, HD-DVD) possessing specific physical characteristics. If the measured characteristics of the polymer of the optical medium do not coincide with those of polymers authorized to be used to make optical recording media for the reader/player, the optical medium will not be read or played.

### CROSS REFERENCE STATEMENT

This application claims the benefit of U.S. Provisional Application No. 60/186,809, filed Mar. 3, 2000 and U.S. Provisional Application No. 60/196,220, filed Apr. 11, 2000.

### TECHNICAL FIELD

The instant invention relates to a method and apparatus for playing back an optical recording medium. More particularly, the instant invention relates to a digital disc player capable of reading and/or playing an optical disc, for example, a digital versatile disc (DVD), made of selected substrate materials possessing unique physical and chemical characteristics, and which rejects unauthorized discs not made from the selected substrate materials.

### BACKGROUND OF THE INVENTION

Optical media, such as pre-recorded compact discs (CD's), traditionally contain information such as computer programs, audio and video recordings, and the like. In the past, these recorded discs have been illegally copied or pirated and sold in a black market without payment of appropriate fees associated with replicating copyright protected assets to the software companies, recording artists or movie studios, as well as optical media format royalties to the original electronic equipment manufacturers, that is consumer electronics industry. Additionally, the optical media discs have traditionally been made from polymers such as polycarbonate, which can be easily obtained in order to make illegal duplications of optical media discs.

Numerous methods and instruments have been created in the past in order to identify and authenticate such articles as optical discs. WO 97/24699 discloses a method and apparatus for authentication of articles for the protection from forgery and counterfeiting.

Recently, research and development has been directed at obtaining optical media discs which offer enhanced data capacity for high density formats (for example, HD-DVD), for example containing 30 or more Gigabytes of information content. Wavelengths of light sources are generally different in the HD-DVD, DVD, and CD formats. While the wavelength of the light source for reproduction of a CD is approximately 780 nm, the wavelength of the light source for reproduction of a DVD is approximately 650 nm. For reproduction in the HD-DVD format, a light source emitting light having a shorter wavelength of approximately 400 nm will be required.

High density formats will allow more information storage per disc, thus allowing for enhanced features in movies, superior format for digital high definition television, more songs per disc, enhanced software packages, etc. Current research is directed to identifying polymers which can be utilized in such applications. Such applications will also require new players/readers having the ability to read such high density formats. However, the potential for illegal manufacture or duplication of such discs still remains and will represent significant financial loss to the entertainment industry and other content holders and creators, due to the increasing popularity of such formats.

Therefore, there remains a need for an optical disk reader/player that recognizes the physical characteristics of high density discs made from authorized polymers and that can reproduce such discs. There also remains a need for a reader/player that will not play or read the contents of illegally manufactured high density discs not made from authorized polymers and which do not possess the physical characteristics of authorized polymers.

### SUMMARY OF THE INVENTION

In light of the above-referenced problems, it is an object of the present invention to provide a digital disc reader/player capable of reproducing (that is, reading/playing data, video or audio) a digital versatile disc (DVD) or other optical recording media (for example, CD, HD-DVD) made of selected substrate materials possessing unique physical and chemical characteristics while rejecting unauthorized discs not made from the selected substrate materials.

It is another object of the present invention to determine the infrared spectrum of the polymer or polymer blend of a disc placed in the reader/player in order to distinguish authorized from unauthorized discs.

It is yet another object of the present invention to determine the infrared transmittance of the polymer or polymer blend of a disc at one or more wavelengths or wavelength regions in order to distinguish authorized from unauthorized discs.

It is yet another object of the present invention to determine the Raman spectrum of the polymer or polymer blend of a disc placed in the reader/player in order to distinguish authorized from unauthorized discs.

It is yet another object of the present invention to determine Raman scattering of the polymer or polymer blend of a disc at one or more wavelengths or wavelength regions in order to distinguish authorized from unauthorized discs.

It is another object of the present invention to determine the near infrared spectrum of the polymer or polymer blend of a disc placed in the reader/player in order to distinguish authorized from unauthorized discs.

It is yet another object of the present invention to determine near infrared transmittance of the polymer or polymer blend of a disc at one or more wavelengths or wavelength regions in order to distinguish authorized from unauthorized discs.

It is another object of the present invention to determine the ultraviolet spectrum of the polymer or polymer blend of a disc placed in the reader/player in order to distinguish authorized from unauthorized discs.

It is yet another object of the present invention to determine ultraviolet transmittance of the polymer or polymer blend of a disc at one or more wavelengths or wavelength regions in order to distinguish authorized from unauthorized discs.

It is yet another object of the present invention to determine the refractive index of the polymer or polymer blend of a disc in order to distinguish authorized from unauthorized discs.

It is yet another object of the present invention to determine the dielectric constant of the polymer or polymer blend of a disc in order to distinguish authorized from unauthorized discs.

It is yet another object of the present invention to determine the surface energy of the polymer or polymer blend of a disc in order to distinguish authorized from unauthorized discs.

It is yet another object of the present invention to determine the mass density of the polymer or polymer blend of a disc in order to distinguish authorized from unauthorized discs.

It is yet another object of the present invention to determine the fluorescence of the polymer or polymer blend of a disc in order to distinguish authorized from unauthorized discs.

### BRIEF DESCRIPTION OF THE DRAWINGS

FIG. 1 is a block/schematic diagram of a conventional reader/player;

FIG. 2 is a block/schematic diagram of an apparatus embodiment of the instant invention that incorporates an infrared spectrometer;

FIG. 3 is a block/schematic diagram of an apparatus embodiment of the instant invention that incorporates an infrared photometer;

FIG. 4 is a block/schematic diagram of an apparatus embodiment of the instant invention that incorporates a Raman spectrometer;

FIG. 5 is a block/schematic diagram of an apparatus embodiment of the instant invention that incorporates a Raman photometer;

FIG. 6 is a block/schematic diagram of an apparatus embodiment of the instant invention that incorporates a near infrared spectrometer;

FIG. 7 is a block/schematic diagram of an apparatus embodiment of the instant invention that incorporates a near infrared photometer;

FIG. 8 is a block/schematic diagram of an apparatus embodiment of the instant invention that incorporates an ultraviolet spectrometer;

FIG. 9 is a block/schematic diagram of an apparatus embodiment of the instant invention that incorporates an ultraviolet photometer;

FIG. 10 is a block/schematic diagram of an apparatus embodiment of the instant invention that incorporates a refractive index detector;

FIG. 11 is a block/schematic diagram of an apparatus embodiment of the instant invention that incorporates a dielectric constant detector;

FIG. 12 is a block/schematic diagram of an apparatus embodiment of the instant invention that incorporates a surface energy detector;

FIG. 13 is a block/schematic diagram of an apparatus embodiment of the instant invention that incorporates a weigh cell;

FIG. 14 is a plot of optical absorbance v. wavelength for three polymers of the instant invention and one polymer (polycarbonate) of the prior art;

FIG. 15 is a plot of optical absorbance v. wavelength for three polymers of the instant invention and one polymer (polycarbonate) of the prior art;

FIG. 16 is a plot of Raman spectra of three polymers of the instant invention and two polymers of the prior art; and

FIG. 17 is a plot of infrared spectra of three polymers of the instant invention and two polymers of the prior art.

### DETAILED DESCRIPTION OF THE PREFERRED EMBODIMENTS

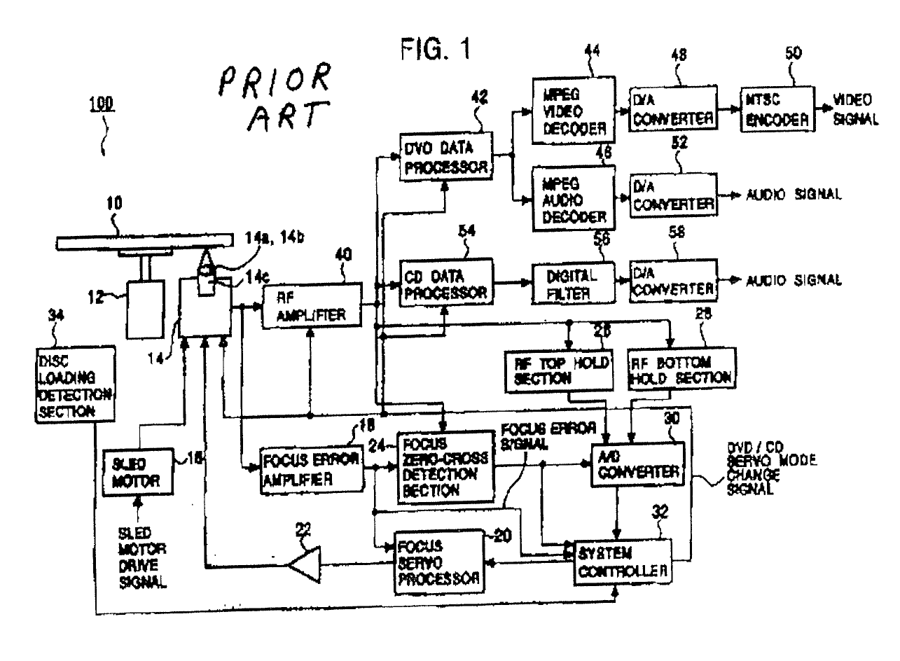

FIG. 1 is a block diagram of a conventional digital disk reader/player 100 as disclosed in U.S. Pat. No. 5,986,985, herein fully incorporated by reference. The following description of the reader/player 100 is provided herein as one example of a conventional reader/player system. However, it should be understood that the instant invention is not limited to any one specific type of reader/player. Instead, the instant invention can be incorporated into any reader/player without limitation. The reader/player 100 reads a signal recorded on the disc 10, and performs subsequent processing to play back data, images and sounds from the disc 10.

The digital disc reader/player 100 has a spindle motor 12, an optical pickup 14, a sled motor 16, a focus error amplifier 18, a focus servo processor 20, a focus actuator driver 22, a focus zero-cross detection section 24, an RF top hold section 26, an RF bottom hold section 28, an analog-to-digital converter (A/D converter) 30, a system controller 32, and a disc loading detection section 34, and each of these elements is itself conventional.

The spindle motor 12 rotates the checked disc 10 at a constant linear velocity. The optical pickup 14 reads the recording signal from the checked disc 10. The optical pickup 14 includes a DVD objective lens 14a for condensing illumination light from a semiconductor laser device (not shown) and conducting light reflected from a signal recording surface of the checked disc 10 to a photodiode (not shown), and a focus actuator 14c for adjusting the focus position by moving the objective lens 14a in a direction perpendicular to the recording surface of the checked disc 10.

The focus error amplifier 18 forms a focus error signal from a signal output from the optical pickup 14 and amplifies the focus error signal. An output signal from the focus error amplifier 18 is input to the focus servo processor 20 and to the focus zero-cross detection section 24. The focus error signal exhibits a voltage value according to the distance between the objective lens 14a in the optical pickup 14 and the in-focus position (the distance between the focal point of the objective lens and the position of the objective lens when the focal point coincides with the signal recording surface of the checked disc 10).

The focus servo processor 20 forms a signal necessary for the focus servo by performing phase compensation of a high-frequency component and amplification of a low-frequency component of the input focus error signal, and amplifies this signal to generate a voltage necessary for driving the focus actuator driver 22. The focus actuator driver 22 energizes the focusing coil of the focus actuator 14c in the optical pickup 14 according to the drive voltage applied from the focus servo processor 20. By this energization, the position of the objective lens 14a is moved in a direction perpendicular to the signal recording surface of the checked disc 10.

The system controller 32 performs overall control of the entire digital disc player 100 to play back images and sounds recorded on the checked disc 10. The system controller 32 includes a threshold generator for generating a predetermined threshold value, and a comparator for comparing a peak value of the focus error signal with the threshold value, and a disc discriminator element.

The digital disc player 100 also includes an RF amplifier 40, a DVD data processor 42, an MPEG video decoder 44, an MPEG audio decoder 46, a digital-to-analog converters (D/A converters) 48, 52, and 58, an NTSC encoder 50, a CD data processor 54, and a digital filter 56; all are conventional.

The RF amplifier 40 amplifies the signal output from the optical pickup 14. The focus zero-cross detection section 24 detects a zero-cross of the focus error signal output from the focus error amplifier 18 when the amplitude of the output of the RF amplifier 40 is equal to or larger than a predetermined value. The RF top hold section 26 holds the upper level of the envelop of the signal amplitude (RF signal) output from the RF amplifier 40 while the RF bottom hold section 28 holds the lower level of the envelop of the RF signal amplitude. These levels can be obtained by envelop detection of the RF signal. The difference between these levels represents the total amplitude of the RF signal.

The A/D converter 30 receives the upper and lower levels of the envelop of the RF signal respectively held by the RF top hold section 26 and the RF bottom hold section 28 when a focus zero-cross signal is output from the focus zero-cross detection section 24. The A/D converter 30 converts the voltage level (analog signal) of each of the upper and lower envelop levels into digital data. The digital data corresponding to the upper level and the digital data corresponding to the lower level are input to the system controller 32.

The DVD processor 42 demodulates the signal output from the RF amplifier 40 to recover MPEG data and also performs various digital signal processing functions, such as error correction processing, MPEG video and audio data separation processing and address information extraction processing. The MPEG video decoder 44 decodes the MPEG video data separated by the DVD data processor 42 into MPEG2 video data. The decoded video data is input to the digital-to-analog converter 48 to form a brightness signal Y and color difference signals Cb and Cr. Further, the NTSC encoder 50 constructs an NTSC signal (video signal) from these brightness and color difference signals. The MPEG audio decoder 46 decodes the MPEG audio data separated by the DVD processor 42 into MPEG2 audio data. The decoded audio data is converted into an analog audio signal by being passed through the D/A converter 52.

The DVD player constructed as above uses modulation, error correction and a video encoding different from those of a general CD player so that their signal processing mechanisms are different. The pit size and track pitch of a DVD and a CD are different, and their pickup unit laser wavelength and the numerical aperture of the objective lens are different.

In the DVD or HD-DVD recording/reproducing apparatus, it is important to reduce the size of a focusing spot for the purpose of higher density. To achieve this, first, the laser wavelength is made shorter. Second, the objective lens' numerical aperture may be made larger. Third, a modulation method having an excellent encoding efficiency is used, such as EFM-plus (Eight to Fourteen Modulation plus) is used. EFM-plus is discussed in U.S. Pat. No. 5,995,447, which is incorporated by reference herein.

In order to reproduce information from the high-density optical disk, the pickup unit should be able to form a small focusing spot. The diameter of the focusing spot is proportional to the wavelength λ of light, and inversely proportional to the objective lens' numerical aperture.

The above description of the reader/player 100 is provided herein as one example of a conventional reader/player system. However, it should be understood that the instant invention is not limited to any one specific type of reader/player. Instead, the instant invention can be incorporated into any reader/player without limitation. The central feature of the apparatus of the instant invention is a reader/player that incorporates a detector for detecting a physical characteristic of the polymer (or a material added to the polymer) of the disc (such as its spectra, its light transmittance at one or more wavelengths, its dielectric constant, its surface energy or the weight of the disc) and a system controller coupled to the detector which activates or deactivates the reader/player. Similarly, the central feature of the method of the instant invention is the step of detecting a physical characteristic of the polymer (or a material added to the polymer) of the disc (such as its spectra, its light transmittance at one or more wavelengths, its dielectric constant, its surface energy or the weight of the disc) and the step of activating or deactivating the reader/player depending on the characteristics of the detecting step. The apparatus and method of the instant invention can take an almost unlimited number of specific embodiments. Many specific examples of these embodiments will now be disclosed in detail. However, it should be understood that the instant invention is not limited to only the below-disclosed specific embodiments.

Referring now to FIG. 2, therein is shown a simplified block diagram of a reader/player 200 having many features like the reader player 100 of FIG. 1. The reader/player 200 has a disc 51 inserted into it and incorporates a spindle motor 52. However, the reader/player 200 comprises an infrared spectrometer 53 for determining the infrared spectrum of the polymer of the disc 51. It should be understood that the term “spectrum” is defined broadly in the instant specification and in the claims hereof to include all of the spectral characteristics of the polymer such as absorbance, transmittance, scattering, reflectance fluorescence and emission. The reader/player 200 preferably comprises a total internal reflection prism 54 that is brought into contact with the polymer of the disc when the disc is inserted into the reader/player before the disc is rotated. A beam of infrared light 55 is shown into the total internal reflection prism to facilitate the acquisition of the infrared spectrum of the polymer of the disc 51. The polymers used in the instant invention have a unique infrared spectrum in the wave number range of from 250 to 4000 reciprocal centimeters. If the infrared spectrum of the polymer of the disc 51 does not sufficiently match the infrared spectrum of a polymer of the instant invention, then the disc can be suspected as being a pirate disc and the reader/player 200 system controller will not activate the read or play function of the reader/player 200.

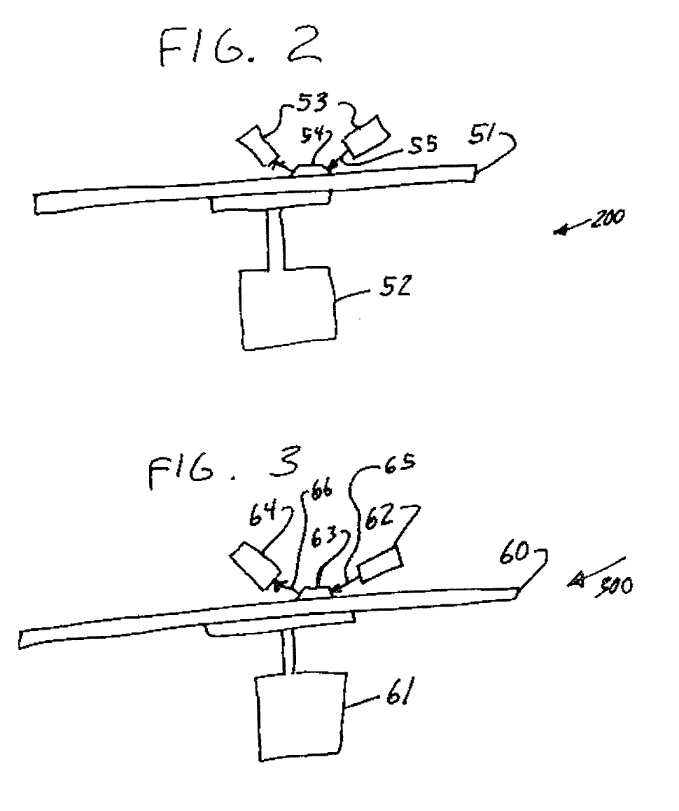

Referring now to FIG. 3, therein is shown a simplified block diagram of a reader/player 300 having many features like the reader player 100 of FIG. 1. The reader/player 300 has a disc 60 inserted into it and incorporates a spindle motor 52. However, the reader/player 300 comprises an infrared photometer, which photometer is comprised of a source of infrared light 62 and an infrared photometer 64 for determining the infrared transmittance of the polymer of the disc 60 at one or more wavelengths or wavelength regions. It should be understood that the term “transmittance” is defined broadly in the instant specification and in the claims hereof to include all of the spectral characteristics of the polymer such as absorbance, transmittance, scattering, reflectance fluorescence and emission at one or more wavelengths or wavelength regions. The reader/player 300 preferably comprises a total internal reflection prism 63 that is brought into contact with the polymer of the disc 60 when the disc 60 is inserted into the reader/player before the disc is rotated. A beam of infrared light 65 is shown into the total internal reflection prism to facilitate the acquisition of the infrared transmittance of the polymer of the disc 60 at one or more wavelengths or wavelength regions. The polymers used in the instant invention have a unique infrared transmittance at various wavelengths in the wave number range of from 250 to 4000 reciprocal centimeters. If the infrared transmittance of the polymer of the disc does not sufficiently match the infrared transmittance of a polymer of the instant invention, then the disc 60 can be suspected as being a pirate disc and the reader/player 300 system controller will not activate the read or play function of the reader/player 300.

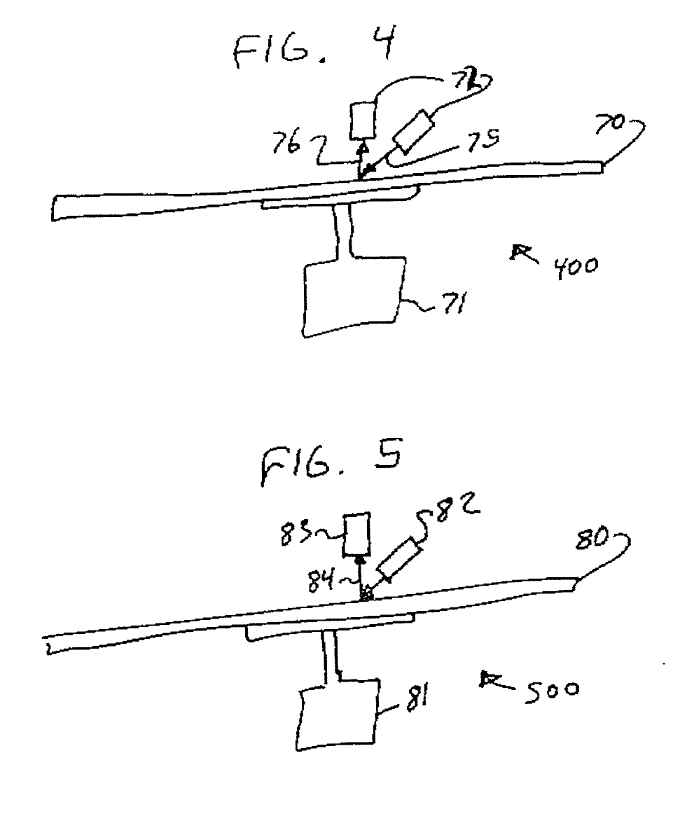

Referring now to FIG. 4, therein is shown a simplified block diagram of a reader/player 400 having many features like the reader player 100 of FIG. 1. The reader/player 400 has a disc 70 inserted into it and incorporates a spindle motor 71. However, the reader/player 400 comprises a Raman spectrometer 72 for determining the Raman spectrum of the polymer of the disc 70. An intense beam of light 75 (preferably from a laser) is shown into the polymer of the disc 70, preferably at the hub of the disk as shown, to facilitate the acquisition of the Raman spectrum of the polymer of the disc 70 by way of the Raman scattering light 76. It should be understood that the intense beam of light 75 can be the read light from the optical pickup 14 of FIG. 1 and that said optical pickup 14 can also incorporate the Raman scattering detector. The polymers used in the instant invention have a unique Raman spectrum in the wave number range of from 250 to 4000 reciprocal centimeters Raman shift. If the Raman spectrum of the polymer of the disc 70 does not sufficiently match the Raman spectrum of a polymer of the instant invention, then the disc 70 can be suspected as being a pirate disc and the reader/player 400 system controller will not activate the read or play function of the reader/player 400.

Referring now to FIG. 5, therein is shown a simplified block diagram of a reader/player 500 having many features like the reader player 100 of FIG. 1. The reader/player 500 has a disc 80 inserted into it and incorporates a spindle motor 81. However, the reader/player 500 comprises an infrared photometer, which photometer is comprised of an intense source of light 82, preferably from a laser, and a photometer 83 for determining the Raman scattering 84 of the polymer of the disc 80 at one or more wavelengths or wavelength regions. Again, it should be understood that the intense source of light 82 can be the read light from the optical pickup 14 of FIG. 1 and that said optical pickup 14 can also incorporate the photometer 83. The polymers used in the instant invention have a unique Raman scattering at various wavelengths in the wave number range of from 250 to 4000 reciprocal centimeters Raman shift. If the Raman scattering of the polymer of the disc 80 does not sufficiently match the Raman scattering of a polymer of the instant invention, then the disc 80 can be suspected as being a pirate disc and the reader/player 500 system controller will not activate the read or play function of the reader/player 500.

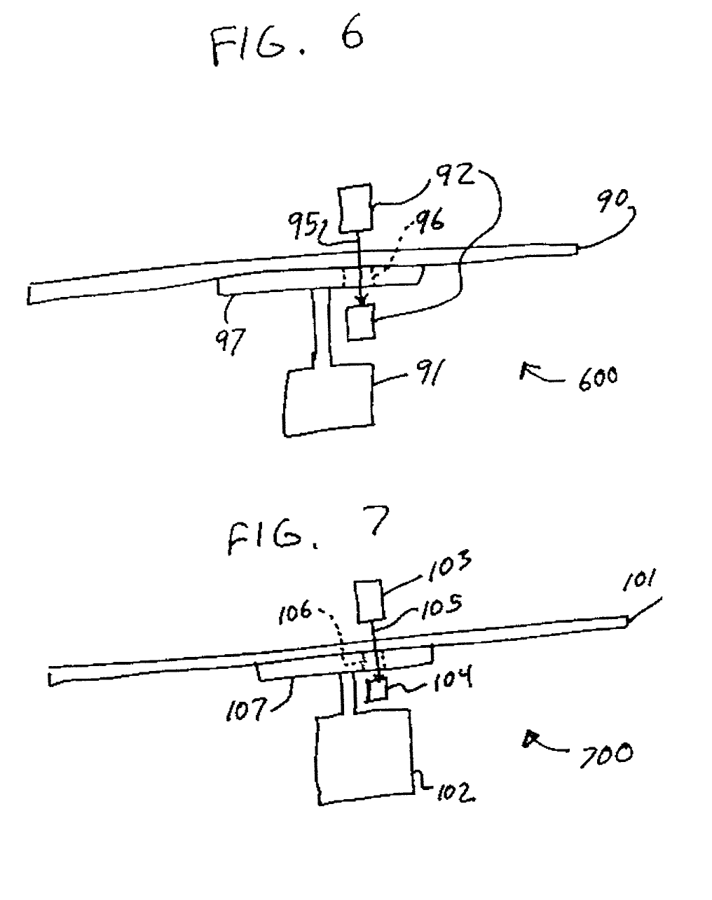

Referring now to FIG. 6, therein is shown a simplified block diagram of a reader/player 600 having many features like the reader player 100 of FIG. 1. The reader/player 600 has a disc 90 inserted into it and incorporates a spindle motor 91. However, the reader/player 600 comprises a near infrared spectrometer 92 for determining the near infrared spectrum of the polymer of the disc 90. A beam of near infrared light 95 is shown through the polymer of the disc 90 (and through opening 96 in disc support flange 97 to facilitate the acquisition of the near infrared spectrum of the polymer of the disc 90. The polymers used in the instant invention have a unique near infrared spectrum in the wavelength range of from 800 to 2500 nanometers. If the near infrared spectrum of the polymer of the disc 90 does not sufficiently match the near infrared spectrum of a polymer of the instant invention, then the disc 90 can be suspected as being a pirate disc and the reader/player 600 system controller will not activate the read or play function of the reader/player 600.

Referring now to FIG. 7, therein is shown a simplified block diagram of a reader/player 700 having many features like the reader player 100 of FIG. 1. The reader/player 700 has a disc 101 inserted into it and incorporates a spindle motor 102. However, the reader/player 700 comprises a near infrared photometer comprises of a source of near infrared light 103 and a near infrared light photometer 104 for determining the near infrared transmission of the polymer of the disc 101 at one or more wavelengths or wavelength regions. A beam of near infrared light 95 is shown through the polymer of the disc 101 (and through opening 106 in disc support flange 107 to facilitate the acquisition of the near infrared transmission of the polymer of the disc 101 at the one or more wavelengths or wavelength regions. The polymers used in the instant invention have a unique near infrared spectrum in the wavelength range of from 800 to 2500 nanometers. If the near infrared transmission of the polymer of the disc 101 does not sufficiently match the near infrared transmission of a polymer of the instant invention at the one or more wavelengths or wavelength regions, then the disc 101 can be suspected as being a pirate disc and the reader/player 700 system controller will not activate the read or play function of the reader/player 700.

Referring now to FIG. 8, therein is shown a simplified block diagram of a reader/player 800 having many features like the reader player 100 of FIG. 1. The reader/player 800 has a disc 110 inserted into it and incorporates a spindle motor 111. However, the reader/player 800 comprises an ultraviolet spectrometer 112 for determining the ultraviolet spectrum of the polymer of the disc 110. A beam of ultraviolet light 113 is shown through the polymer of the disc 110 (and through opening 114 in disc support flange 115 to facilitate the acquisition of the ultraviolet spectrum of the polymer of the disc 110. The polymers used in the instant invention have a unique ultraviolet spectrum in the wavelength range of from 190 to 300 nanometers. If the ultraviolet spectrum of the polymer of the disc 110 does not sufficiently match the ultraviolet spectrum of a polymer of the instant invention, then the disc 110 can be suspected as being a pirate disc and the reader/player 800 system controller will not activate the read or play function of the reader/player 800.

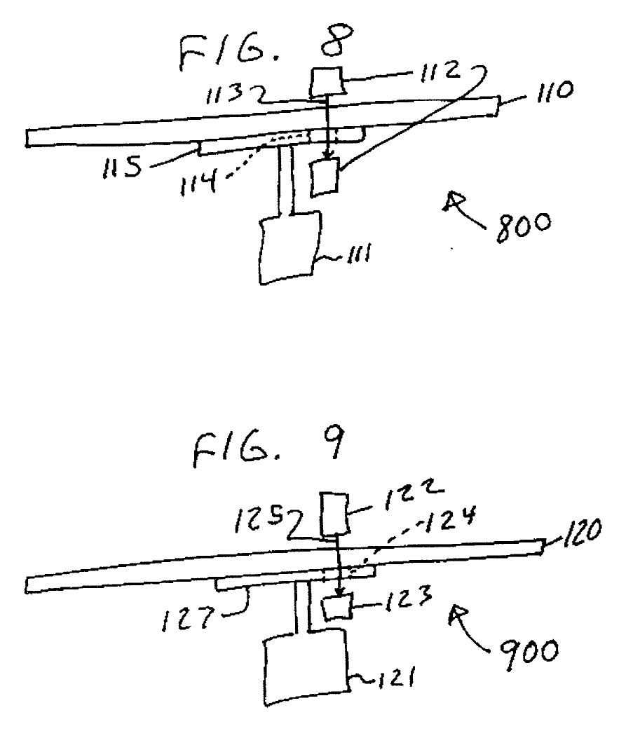

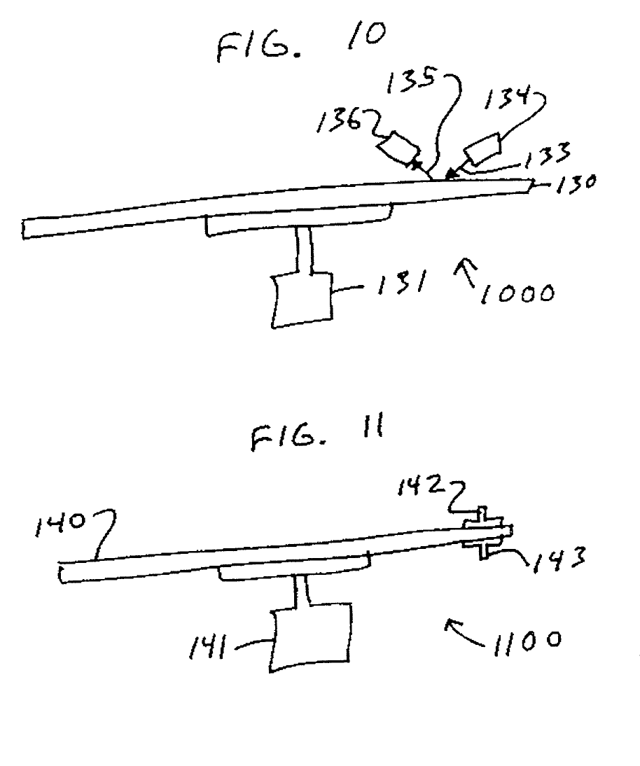

Referring now to FIG. 9, therein is shown a simplified block diagram of a reader/player 900 having many features like the reader player 100 of FIG. 1. The reader/player 900 has a disc 120 inserted into it and incorporates a spindle motor 121. However, the reader/player 900 comprises an ultraviolet photometer comprised of a source of ultraviolet light 122 and an ultraviolet photometer 123 for determining the ultraviolet transmission of the polymer of the disc 120 at one or more wavelengths or wavelength regions. A beam of ultraviolet light 125 is shown through the polymer of the disc 120 (and through opening 124 in disc support flange 127 to facilitate the acquisition of the ultraviolet transmission of the polymer of the disc 120 at one or more wavelengths or wavelength regions. The polymers used in the instant invention have a unique near ultraviolet spectrum in the wavelength range of from 190 to 300 nanometers. If the ultraviolet transmission of the polymer of the disc 120 does not sufficiently match the ultraviolet transmission of a polymer of the instant invention at the one or more wavelengths or wavelength regions, then the disc 120 can be suspected as being a pirate disc and the reader/player 900 system controller will not activate the read or play function of the reader/player 900.

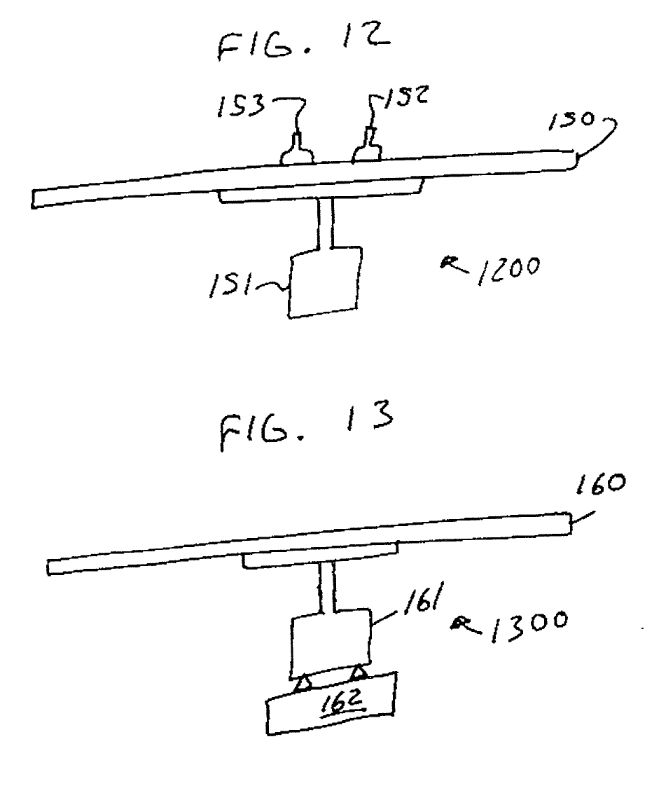

Referring now to FIG. 10, therein is shown a simplified block diagram of a reader/player 1000 having many features like the reader player 100 of FIG. 1. The reader/player 1000 has a disc 130 inserted into it and incorporates a spindle motor 131. However, the reader/player 1000 comprises a refractive index detector for determining the refractive index of the polymer of the disc. A beam of light 133 from light source 134 is directed obliquely to the face of the disc and is reflected as light beam 135 by the aluminum layer of the disc 130 to an angle of reflection sensitive light detector 136 to determine the refractive index of the polymer of the disc 130. The polymers used in the instant invention have a unique refractive index. If the refractive index of the polymer of the disc 130 does not sufficiently match the refractive index of a polymer of the instant invention, then the disc can be suspected as being a pirate disc and the reader/player 1000 system controller will not activate the read or play function of the reader/player 1000.

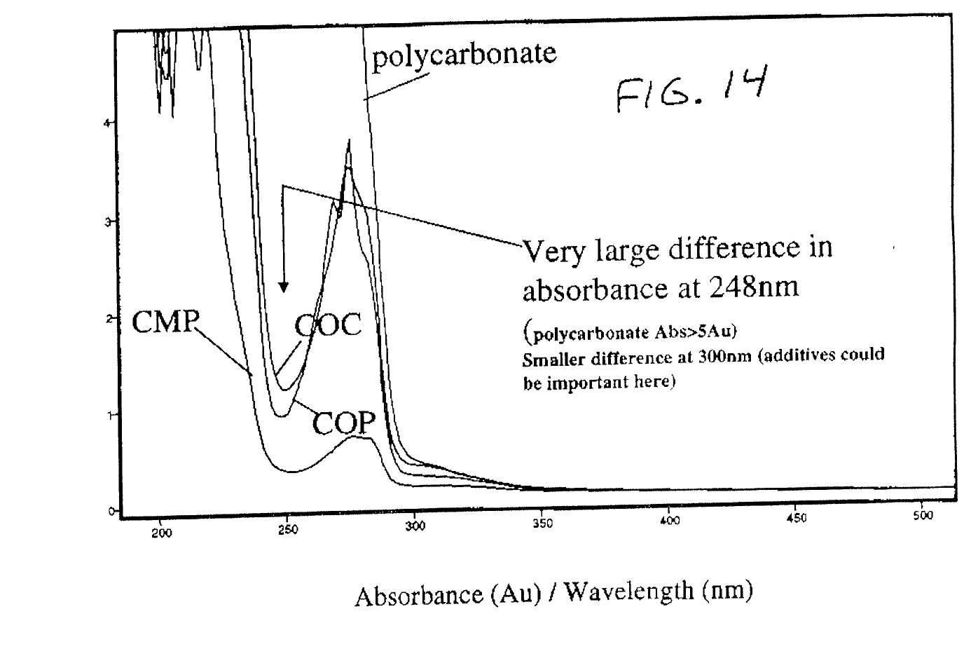

Referring now to FIG. 11, therein is shown a simplified block diagram of a reader/player 1100 having many features like the reader player 100 of FIG. 1. The reader/player 1100 has a disc 140 inserted into it and incorporates a spindle motor 141. However, the reader/player 1100 comprises a dielectric constant detector for determining the dielectric constant of the polymer of the disc 140. A pair of juxtaposed electrode plates 142 and 143 are clamped to the disc 140 before it is rotated. The plates 142 and 143 are used in an inductor/capacitor alternating current electrical circuit to determine the dielectric constant of the polymer of the disc 140. The polymers used in the instant invention have a unique dielectric constant. If the dielectric constant of the polymer of the disc 140 does not sufficiently match the dielectric constant of a polymer of the instant invention, then the disc 140 can be suspected as being a pirate disc and the reader/player 1100 system controller will not activate the read or play function of the reader/player 1100.

Referring now to FIG. 12, therein is shown a simplified block diagram of a reader/player 1200 having many features like the reader player 100 of FIG. 1. The reader/player 1200 has a disc 150 inserted into it and incorporates a spindle motor 151. However, the reader/player 1200 comprises a static electricity generator for determining the surface energy of the polymer of the disc. A hair brush 152 is brought into contact with the rotating disc 150 at the hub of the disc to generate static electricity of a voltage measured by electrically conductive brush 153 to determine the surface energy of the polymer of the disc 150. The polymers used in the instant invention have a unique surface energy. If the surface energy of the polymer of the disc does not sufficiently match the surface energy of a polymer of the instant invention, then the disc 150 can be suspected as being a pirate disc and the reader/player 1200 system controller will not activate the read or play function of the reader/player 1200.

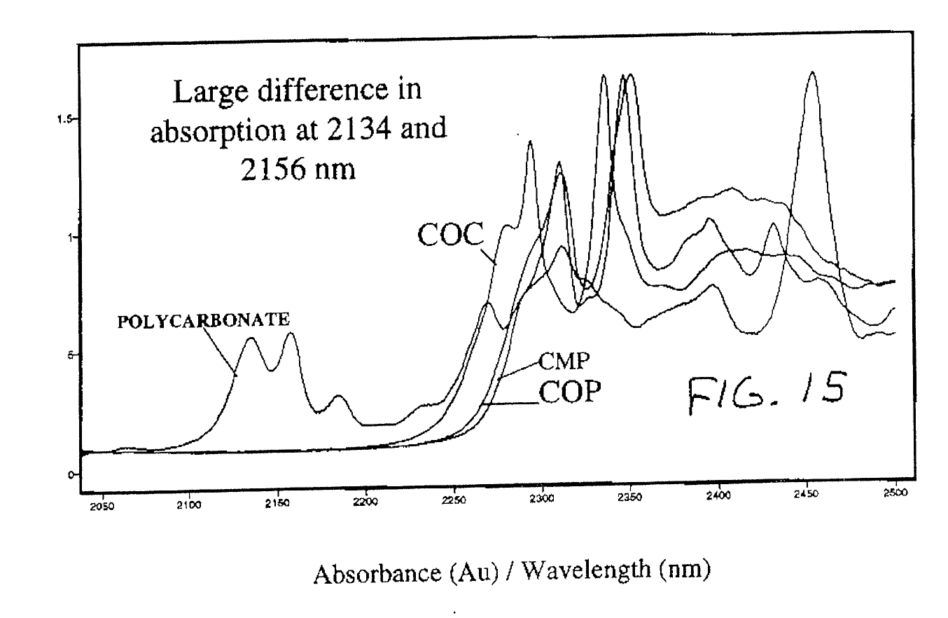

Referring now to FIG. 13, therein is shown a simplified block diagram of a reader/player 1300 having many features like the reader player 100 of FIG. 1. The reader/player 1300 has a disc 160 inserted into it and incorporates a spindle motor 161. However, the reader/player 1300 comprises a weigh cell 162 for determining the weight of the disc 160. The polymers used in the instant invention have a uniquely low mass density (for example as expressed in grams per cubic centimeter) and therefore produce lighter discs (assuming the same disc thickness and diameter). If the weight of the disc 160 does not sufficiently match the weight of a disc made of a polymer of the instant invention, then the disc 160 can be suspected as being a pirate disc and the reader/player 1300 system controller will not activate the read or play function of the reader/player 1200. Not shown in FIG. 13 is a system for determining the thickness and diameter of the disc 160, but such systems are known in the art and can be used in the instant invention to provide a correction as discussed above. Further, it should be pointed out that the weigh cell 162 is not the only means of determining the weight of the disc 160. The acceleration of the disc 160 by the spindle motor 161 can also be used to determine the weight of the disc 160 as described in JP 6293817. Thus, the specific system used to determine the weight of the disc 160 is not critical in this embodiment of the instant invention.

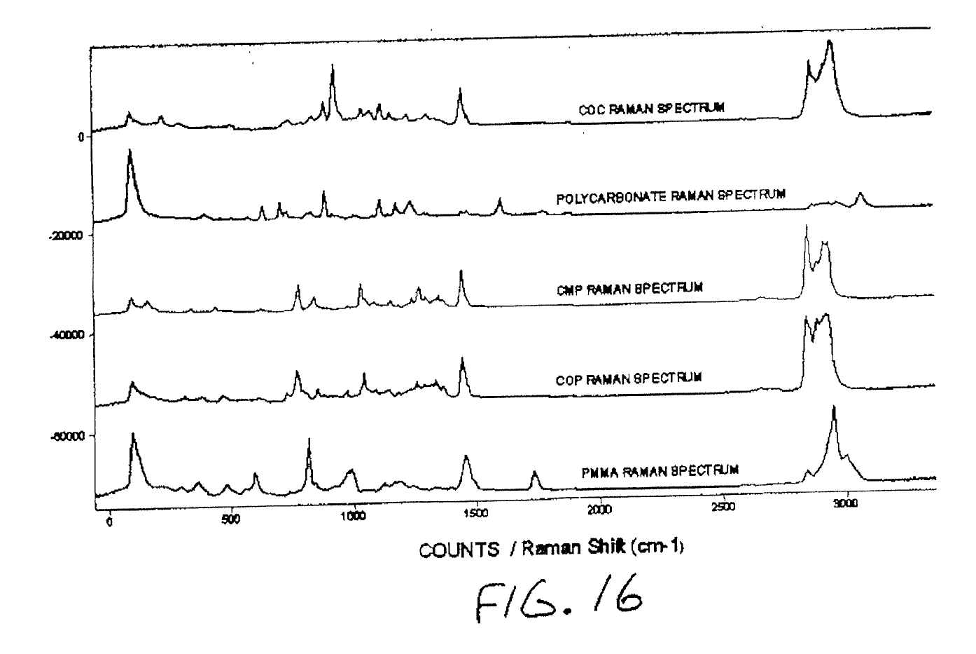

Referring now to FIG. 14, therein is shown a plot of optical absorbance v. wavelength for three polymers of the instant invention and one polymer of the prior art (polycarbonate) in the wavelength range of from 200 to 500 nanometers. With reference to the embodiment of the instant invention of FIG. 8, the data in FIG. 14 shows the difference in the ultraviolet spectra of the polymers of the instant invention in comparison to the prior art polymer. Similarly, in reference to the embodiment of the instant invention of FIG. 9, the data in FIG. 14 shows the difference in the ultraviolet transmission of the polymers of the instant invention in comparison to the prior art polymer at, for example, 248 nanometers.

Referring now to FIG. 15, therein is shown a plot of optical absorbance v. wavelength for three polymers of the instant invention and one polymer of the prior art (polycarbonate) in the wavelength range of from 2050 to 2500 nanometers. With reference to the embodiment of the instant invention of FIG. 6, the data in FIG. 14 shows the difference in the near infrared spectra of the polymers of the instant invention in comparison to the prior art polymer. Similarly, in reference to the embodiment of the instant invention of FIG. 7, the data in FIG. 14 shows the difference in the near infrared transmission of the polymers of the instant invention in comparison to the prior art polymer at, for example, 2134 and 2156 nanometers.

Referring now to FIG. 16, therein is shown a plot of Raman spectra for COC, CMP and COP as well as polycarbonate and polymethyl methacrylate (PMMA). FIG. 16 shows the unique Raman spectra characteristics of three polymers of the instant invention in comparison to two polymers of the prior art.

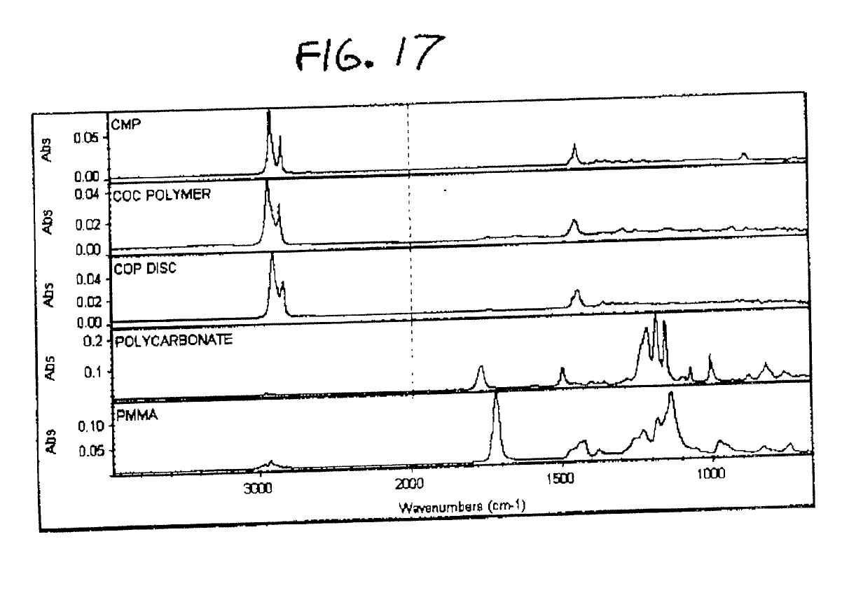

Referring now to FIGS. 14, 15, 16 and 17, mention is made of “CMP”, “COC” and “COP”. These terms (and the polymers of the instant invention in general) will now be defined. CMP is a “hydrogenated aromatic polymer” as defined in greater detail below. COP is a “cyclic-olefin-polymer” as defined in greater detail below. COC is a “cyclic-olefin-copolymer” as defined in greater detail below. The polymers of the instant invention will now be defined in greater detail.

The polymers of the instant invention are preferably an amorphous saturated hydrocarbon thermoplastic. The term “saturated” refers to the amount of olefinic bonds within the chemical structure. As used herein, saturated refers to a polymer wherein less than 10 percent of the carbon-carbon bonds are olefinic or unsaturated in nature, generally less than 7.5 percent, typically less than 5 percent, advantageously less than 2 percent, more advantageously less than 1.5 percent, preferably less than 1 percent, more preferably less than 0.5 percent and most preferably less than 0.2 percent being olefinic or unsaturated in nature. These types of polymers include, but are not limited to, hydrogenated aromatic polymers, cyclic-olefin-(co)polymers and hydrogenated ring opening metathesis polymers. As discussed elsewhere herein, the polymers of the instant invention are distinguished from conventional prior art polymers, such as polycarbonate, by a detectable distinctive physical characteristic such as a distinctive spectral characteristic.

Hydrogenated aromatic polymers include any polymeric material containing a pendant aromatic functionality which has been subsequently hydrogenated. Pendant aromatic refers to a structure wherein the aromatic group is a substituent on the polymer backbone and not embedded therein. Preferred aromatic groups are C₆₋₂₀ aryl groups, especially phenyl. These polymers may also contain (prior to hydrogenation) other olefinic groups in addition to the aromatic groups. In one embodiment, the polymer is derived from a monomer of the formula:

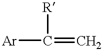

wherein R′ is hydrogen or alkyl, Ar is phenyl, halophenyl, alkylphenyl, alkylhalophenyl, naphthyl, pyridinyl, or anthracenyl, wherein any alkyl group contains 1 to 6 carbon atoms which may be mono or multisubstituted with functional groups such as halo, nitro, amino, cyano, carbonyl and carboxyl. More preferably Ar is phenyl or alkyl phenyl with phenyl being most preferred. Typical vinyl aromatic monomers which can be used to produce such aromatic polymers include styrene, alpha-methylstyrene, all isomers of vinyl toluene, especially paravinyltoluene, all isomers of ethyl styrene, propyl styrene, vinyl biphenyl, vinyl naphthalene, vinyl anthracene and the like, and mixtures thereof. Homopolymers may have any stereostructure including syndiotactic, isotactic or atactic; however, atactic polymers are preferred. In addition, hydrogenated copolymers derived from these aromatic monomers, including random, pseudo random, block and grafted copolymers, may be used in the process of the present invention. For example, hydrogenated copolymers of vinyl aromatic monomers and comonomers selected from: nitriles, acrylates, acids, ethylene, propylene, maleic anhydride, maleimides, vinyl acetate, and vinyl chloride may also be used. Exemplary copolymers include hydrogenated styrene-acrylonitrile, styrene-alpha-methylstyrene and styrene-ethylene. Hydrogenated block copolymers of vinyl aromatic monomers and conjugated dienes such as butadiene, isoprene may also be used. Examples include styrene-butadiene, styrene-isoprene, styrene-butadiene-styrene and styrene-isoprene-styrene copolymers. Further examples of block copolymers may be found in U.S. Pat. No. 4,845,173, U.S. Pat. No. 4,096,203, U.S. Pat. No. 4,200,718, U.S. Pat. No. 4,210,729, U.S. Pat. No. 4,205,016, U.S. Pat. No. 3,652,516, U.S. Pat. No. 3,734,973, U.S. Pat. No. 3,390,207, U.S. Pat. No. 3,231,635, and U.S. Pat. No. 3,030,346. Blends of such hydrogenated polymers with other polymers including impact modified, grafted rubber containing aromatic polymers may also be used. In one embodiment, the hydrogenated aromatic polymer is polycyclohexylethylene (PCHE) prepared by hydrogenating atactic polystyrene as described in U.S. Pat. No. 5,700,878, herein incorporated by reference.

The hydrogenated vinyl aromatic polymers which are especially preferred for use in the present invention include any aromatic polymer as described above, which has been hydrogenated to a level of at least 80 percent aromatic hydrogenation, generally at least 85 percent, typically at least 90 percent, advantageously at least 95 percent, more advantageously at least 98 percent, preferably at least 98 percent, more preferably at least 99.5 percent, and most preferably at least 99.8 percent. Methods of hydrogenating aromatic polymers are well known in the art such as that described in U.S. Pat. No. 5,700,878 by Hahn and Hucul, wherein aromatic polymers are hydrogenated by contacting the aromatic polymer with a hydrogenating agent in the presence of a silica supported metal hydrogenation catalyst having a narrow pore size distribution and large pores. The level of hydrogenation in hydrogenated vinyl aromatic polymers can be determined using UV-VIS spectrophotometry. If a diene copolymer is used, the level of hydrogenation in hydrogenated diene polymers is determined using proton NMR.

The weight average molecular weight (Mw) of the aromatic polymers which are hydrogenated is typically from 10,000 to 3,000,000, more preferably from 50,000 to 1,000,000, and most preferably from 50,000 to 500,000. As referred to herein, Mw refers to the weight average molecular weight as determined by gel permeation chromatography (GPC).

Cyclic-olefin-polymers and copolymers are polymerized cycloolefin monomers exemplified by norbornene-type polymers such as are described in U.S. Pat. No. 5,115,041, U.S. Pat. No. 5,142,007, U.S. Pat. No. 5,143,979, all of which are incorporated herein by reference. The cycloolefin moiety may be substituted or unsubstituted. Suitable cycloolefin monomers include substituted and unsubstituted norbornenes, dicyclopentadienes, dihydrodicyclopentadienes, trimers of cyclopentadiene, tetracyclododecenes, hexacycloheptadecenes, ethylidenyl norbornenes and vinylnorbornenes. Substituents on the cycloolefin monomers include hydrogen, alkyl alkenyl, and aryl groups of 1 to 20 carbon atoms and saturated and unsaturated cyclic groups of 3 to 12 carbon atoms which can be formed with one or more, preferably two, ring carbon atoms. The substituents on the cycloolefin monomers can be any which do not poison or deactivate the polymerization catalyst. Examples of preferred monomers include but are not limited to dicyclopentadiene, methyltetracyclo-dodecene, 2-norbornene, and other norbornene monomers such as 5-methyl-2-norbornene, 5,6-dimethyl-2-norbornene, 5-ethyl-2-norbornene, 5-ethylidenyl-2-norbornene, 5-butyl-2-norbornene, 5-hexyl-2-norbornene, 5-octyl-2-norbornene, 5-phenyl-2-norbornene, 5-dodecyl-2-norbornene, 5-isobutyl-2-norbornene, 5-octadecyl-2-norbornene, 5-isopropyl-2-norbornene, 5-p-toluyl-2-norbornene, 5-α-naphthyl-2-norbornene, 5-cyclohexyl-2-norbornene, 5-isopropenyl-2-norbornene, 5-vinyl-2-norbornene, 5,5-dimethyl-2-norbornene, tricyclopentadiene (or cyclopentadiene trimer), tetracyclopentadiene (or cyclopentadiene tetramer), dihydrodicyclopentadiene (or cyclopentene-cyclopentadiene co-dimer), methyl-cyclopentadiene dimer, ethyl-cyclopentadiene dimer, tetracyclododecene 9-methyl-tetracyclo[6,2,1,1^{3,6}O^{2,7}]dodecene-4, (or methyl-tetracyclododecene), 9-ethyl-tetracyclo[6,2,1,1^{3,6}O^{2,7}]dodecene-4, (or ethyl-tetracyclododecene), 9-hexyl-tetracyclo-[6,2,1,1^{3,6}O^{2,7}]dodecene-4,9-decyl-tetracyclo[6,2,1,1^{3,6}O^{2,7}]dodecene-4,9-decyl-tetracyclo[6,2,1,1^{3,6}O^{2,7}]dodecene-4,9,10-dimethyl-tetracyclo[6,2,1,1^{3,6}O^{2,7}]dodecene-4,9-methyl-10-ethyl-tetracyclo[6,2,1,1^{3,6}O^{2,7}]dodecene-4,9-cyclohexyl-tetracyclo[6,2,1,1^{3,6}O^{2,7}]dodecene-4,9-chloro-tetracyclo[6,2,1,1^{3,6}O^{2,7}]dodecene-4,9-bromo-tetracyclo[6,2,1,1^{3,6}O^{2,7}]dodecene-4,9-fluoro-tetracyclo[6,2,1,1^{3,6}O^{2,7}]dodecene-4,9-isobutyl-tetracyclo[6,2,1,1^{3,6}O^{2,7}]dodecene-4, and 9,10-dichlorotetracyclo[6,2,1,1^{3,6}O^{2,7}]-dodecene-4.

Polymers comprising two or more different types of monomeric units are also suitable. For example, copolymers of methyltetracyclododecane (MTD) and methylnorbornene (MNB) are especially suitable. More preferably, the polymers comprise three or more different types of monomeric units, for example, terpolymers, including MTD, MNB and dicyclopentadiene (DCPD).

Ring opening metathesis polymers include polymers prepared by metathesis ring opening (co)polymerization of a norbornene or tetracyclododecene, such as those described in JP-85/26,024 and U.S. Pat. No. 5,053,471, which are incorporated herein by reference.

FIGS. 14, 15, 16 and 17 show unique ultraviolet, near infrared, Raman and infrared spectral characteristics of example polymers of the instant invention. Not shown, but never-the-less apparent, are plots and other data indicating the unique physical characteristics of the polymers of the instant invention such as characteristics related to dielectric constant, refractive index, surface energy and mass density.

Referring now to FIG. 14, it will be noticed that the example polymers of the instant invention (CMP, COC and COP) all show a minimum in ultraviolet light absorbance at about 248 nanometers while the absorbance of polycarbonate at 248 nanometers is essentially infinite. Thus, if the light source for reading the optical media (for example, the laser of optical pickup 14 of FIG. 1) has a wavelength of about 248 nanometers, then the object of the instant invention is accomplished automatically if the polymer of the pirate disc is polycarbonate or other polymer having an absorbance at about 248 nanometers which is significantly greater (more than twice) than the absorbance of a polymer of the instant invention.

When the polymers of the instant invention are intended to make articles that are not an optical recording medium, then a material can be added to such polymers to distinguish such polymers from polymers of the instant invention that are intended to make an optical recording medium. Using this embodiment, polymers of the instant invention that are not intended to make articles that are not an optical recording medium can not be successfully diverted to make an unauthorized optical recording medium. More specifically, the apparatus for reading and reproducing an optical recording medium, that is, the reader/player, comprises a detector for detecting a physical characteristic of a material added to such a polymer and a control system coupled to said detector that deactivates said reading and reproducing apparatus if said detector detects said added material. The method used in this embodiment comprises the steps of detecting a physical characteristic of a material added to such a polymer to produce a blend and then deactivating the reading and reproducing apparatus if said material is detected in the blend. Thus, even if the blend is used to make an optical recording medium, the optical recording medium would not be read or played, that is, the use of the blend to make an optical recording medium would be “hindered”.

The specific detectable material added to such a polymer is not critical in this embodiment instant invention. For example, the added material can change the fluorescence characteristics of the polymer, the refractive index of the polymer, the surface energy of the polymer, the weight density of the polymer, or the Raman, infrared, near infrared, visible or ultraviolet spectrum or transmission of the polymer, such as by blending a filler, a silicone oil, steric acid, a UV stabilizer, a dye, an antioxidant, or even another polymer such as polycarbonate or polystyrene with the polymer. The amount of material so added needs to be sufficient to change the physical characteristics of the polymer sufficiently that such change can be reliably detected.

For example, blending 700 parts per million of Irganox 1010 brand antioxidant with the polymer is sufficient to change the fluorescence of the polymer so that a fluorescence detector in the reader/player can detect the antioxidant and thus defeat the use of such a polymer to make an unauthorized optical recording medium. If the light source for reading the optical media (for example, the laser of optical pickup 14 of FIG. 1) has a wavelength of about 248 nanometers, then adding a UV absorber to the polymer that decreases the UV transmission of the polymer at about 248 nanometers so that the optical media can not be read will automatically accomplish the object of this embodiment of the instant invention. The reader/player to be used in this embodiment of the instant invention can take an almost unlimited number of specific forms. For example, the reader/players of FIGS. 2-13 can all be so used.

1. An improved optical recording medium reader/player, wherein the improvement comprises:
a detector for detecting a physical characteristic of a polymer of an optical recording medium;
a control system coupled to said detector which activates or deactivates said reader/player based upon an output of said detector.

2. The apparatus of claim 1, wherein the detector is an infrared spectrometer.

3. The apparatus of claim 1, wherein the detector is an infrared photometer.

4. The apparatus of claim 1, wherein the detector is a near infrared spectrometer.

5. The apparatus of claim 1, wherein the detector is an ultraviolet spectrometer.

6. The apparatus of claim 1, wherein the detector is an ultraviolet photometer.

7. The apparatus of claim 1, wherein the detector is a Raman spectrometer.

8. The apparatus of claim 1, wherein the detector is a Raman photometer.

9. The apparatus of claim 1, wherein the detector is a refractive index detector.

10. The apparatus of claim 1, wherein the detector is a dielectric constant detector.

11. The apparatus of claim 1, wherein the detector is a surface energy detector.

12. The apparatus of claim 1, wherein the detector is a weigh cell.

13. An improved method of reading/playing an optical recording medium using a reader/player apparatus, wherein the improvement comprises the steps of:
detecting a physical characteristic of a polymer of an optical recording medium; and
activating or deactivating said reader/player apparatus based upon the detected physical characteristic.

14. The method of claim 13, wherein the physical characteristic is the infrared spectrum of the polymer.

15. The method of claim 13, wherein the physical characteristic is the infrared transmission of the polymer.

16. The method of claim 13, wherein the physical characteristic is the near infrared spectrum of the polymer.

17. The method of claim 13, wherein the physical characteristic is the near infrared transmission of the polymer.

18. The method of claim 13, wherein the physical characteristic is the ultraviolet spectrum of the polymer.

19. The method of claim 13, wherein the physical characteristic is the ultraviolet transmission of the polymer.

20. The method of claim 13, wherein the physical characteristic is the Raman spectrum of the polymer.

21. The method of claim 13, wherein the physical characteristic is the Raman scattering of the polymer.

22. The method of claim 13, wherein the physical characteristic is the refractive index of the polymer.

23. The method of claim 13, wherein the physical characteristic is the dielectric constant of the polymer.

24. The method of claim 13, wherein the physical characteristic is the surface energy of the polymer.

25. The method of claim 13, wherein the physical characteristic is the mass density of the polymer.

26. An improved optical recording medium reader/player, wherein the improvement comprises: a light source for reading an optical recording medium, the light source having a wavelength of about 248 nanometers.

27. An improved method of reading/playing an optical recording medium using a reader/player apparatus, wherein the improvement comprises the step of: reading an optical recording medium at a wavelength of about 248 nanometers.

28. An improved optical recording medium reader/player, wherein the improvement comprises:
a detector for detecting a physical characteristic of a material added to a polymer of an optical recording medium; and
a control system coupled to said detector which deactivates said reader/player if said detector detects said material.

29. The apparatus of claim 28, wherein the detector is an infrared spectrometer.

30. The apparatus of claim 28, wherein the detector is an infrared photometer.

31. The apparatus of claim 28, wherein the detector is a near infrared spectrometer.

32. The apparatus of claim 28, wherein the detector is an ultraviolet spectrometer.

33. The apparatus of claim 28, wherein the detector is an ultraviolet photometer.

34. The apparatus of claim 28, wherein the detector is a Raman spectrometer.

35. The apparatus of claim 28, wherein the detector is a Raman photometer.

36. The apparatus of claim 28, wherein the detector is a refractive index detector.

37. The apparatus of claim 28, wherein the detector is a dielectric constant detector.

38. The apparatus of claim 28, wherein the detector is a surface energy detector.

39. The apparatus of claim 28, wherein the detector is a weigh cell.

40. The apparatus of claim 28, wherein the detector is a fluorescence detector.

41. An improved method for reading/playing an optical recording medium using a reader/player apparatus, wherein the improvement comprises the steps of:
detecting a physical characteristic of a material added to a polymer of an optical recording medium; and
deactivating said reader/player apparatus if said material is detected.

42. The method of claim 41, wherein the physical characteristic is the infrared spectrum of the material.

43. The method of claim 41, wherein the physical characteristic is the infrared transmission of the material.

44. The method of claim 41, wherein the physical characteristic is the near infrared spectrum of the material.

45. The method of claim 41, wherein the physical characteristic is the near infrared transmission of the material.

46. The method of claim 41, wherein the physical characteristic is the ultraviolet spectrum of the material.

47. The method of claim 41, wherein the physical characteristic is the ultraviolet transmission of the material.

48. The method of claim 41, wherein the physical characteristic is the Raman spectrum of the material.

49. The method of claim 41, wherein the physical characteristic is the Raman scattering of the material.

50. The method of claim 41, wherein the physical characteristic is the refractive index of the material.

51. The method of claim 41, wherein the physical characteristic is the dielectric constant of the material.

52. The method of claim 41, wherein the physical characteristic is the surface energy of the material.

53. The method of claim 41, wherein the physical characteristic is the mass density of the material.

54. The method of claim 41, wherein the physical characteristic is the fluorescence of the material.

55. A method for hindering the use of amorphous saturated hydrocarbon thermoplastic to produce an optical recording medium, comprising the step of: blending a material with the amorphous saturated hydrocarbon thermoplastic to produce a blend, the blend having a detectably different physical characteristic than the amorphous saturated hydrocarbon thermoplastic so that if the blend is used to produce an optical recording medium, then a detector incorporated into a reader/player apparatus for reading/playing the optical recording medium can be used to detect the different physical characteristic and deactivate the reader/player apparatus.

56. The method of claim 55, wherein the physical characteristic is the infrared spectrum of the material.

57. The method of claim 55, wherein the physical characteristic is the infrared transmission of the material.

58. The method of claim 55, wherein the physical characteristic is the near infrared spectrum of the material.

59. The method of claim 55, wherein the physical characteristic is the near infrared transmission of the material.

60. The method of claim 55, wherein the physical characteristic is the ultraviolet spectrum of the material.

61. The method of claim 55, wherein the physical characteristic is the ultraviolet transmission of the material.

62. The method of claim 55, wherein the physical characteristic is the Raman spectrum of the material.

63. The method of claim 55, wherein the physical characteristic is the Raman scattering of the material.

64. The method of claim 55, wherein the physical characteristic is the refractive index of the material.

65. The method of claim 55, wherein the physical characteristic is the dielectric constant of the material.

66. The method of claim 55, wherein the physical characteristic is the surface energy of the material.

67. The method of claim 55, wherein the physical characteristic is the mass density of the material.

68. The method of claim 55, wherein the physical characteristic is the fluorescence of the material.

69. A method for hindering the use of amorphous saturated hydrocarbon thermoplastic to produce an optical recording medium, the optical recording medium to be read using a reader/player apparatus having a light source for reading the optical recording medium at about 248 nanometers, comprising the step of: blending an ultraviolet absorbing material with the amorphous saturated hydrocarbon thermoplastic to produce a blend, the blend absorbing sufficient light at about 248 nanometers so that if the blend is used to produce an optical recording medium, the optical recording medium can not be read by the reader/player apparatus.
